(19) United States
(12) Patent Application Publication
(10) Pub. No.: US 2006/0049064 A1
(43) Pub. Date: Mar. 9, 2006

(54) Process for electrochemical oxidation of ferrocyanide to ferricyanide

(76) Inventors: Andras Horvath, Turnhout (BE); Jurgen Alois Verbraeken, Vosselaar (BE); Mihaly Novak, Szeged (HU); Alfons Gaston Maria De Knaep, Turnhout (BE)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/533,098

(22) PCT Filed: Sep. 19, 2003
(86) PCT No.: PCT/EP03/50641

§ 371 Date: Apr. 27, 2005

(30) Foreign Application Priority Data
Nov. 4, 2002 (WO) PCT/EP02/12325

(51) Int. Cl. C02F 1/461; C25F 5/00

(52) U.S. Cl. 205/687; 205/703

(57) ABSTRACT

The present invention concerns a process for oxidizing an aqueous phase comprising ferrocyanide (V) which is recovered from an oxidative phenolic coupling reaction, to an aqueous phase comprising ferricyanide (IV), in a divided electrochemical cell, comprising preparing an anolyte comprising pretreating the aqueous phase comprising ferrocyanide (V) which is recovered from an oxidative phenolic coupling reaction by decantation or extraction or filtration; placing the anolyte in contact with an anodic electrode of the divided electrochemical cell; placing a catholyte in contact with a cathodic electrode of the divided electrochemical cell; and applying electrical power to the divided electrochemical cell, wherein the electrical power has an amperage or voltage and wherein the applying is for a time period sufficient to oxidize the ferrocyanide (V) to ferricyanide (IV).

### BACKGROUND OF THE INVENTION

A key step in the synthesis of galantamine (I) 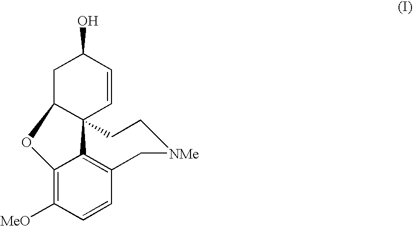
is the oxidative cyclization (intramolecular phenolic coupling) of an intermediate of formula (II) 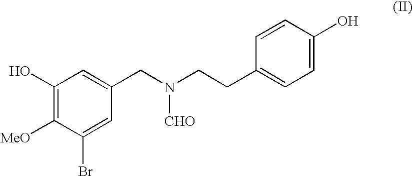
to an intermediate of formula (III) 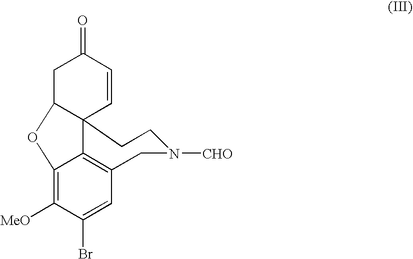
in a two-phase system of an organic solvent and a basic aqueous phase using ferricyanide (IV) as an oxidant (WO-96/12692; WO-96/31458). Preferred organic solvents are aromatic hydrocarbons such as toluene. The aqueous base is preferably an alkali metal carbonate or hydrogen carbonate. The oxidant is preferably potassium ferricyanide or K₃Fe(CN)₆ (IV).

Galantamine (I) is commercially available as Reminyl® (Galantamine hydrobromide) which is approved for the treatment of mild to moderate Alzheimer's Disease and is under development for other indications such as Vascular Dementia, Alzheimer's Disease with cerebrovascular disease, mild cognitive impairment, schizophrenia, Parkinson's Disease and other diseases wherein cognition is impaired.

On full scale production, the ferrocyanide or K₄Fe(CN)₆ (V) aqueous phase waste stream, which has to be incinerated, has a major impact on the cost of the end product galantamine (I). Up to now, no recovery technique for ferrocyanide (V) aqueous waste is available. Besides, it has to be noted that ferricyanide (IV) is a relatively expensive reagent with only few suppliers, which makes recovery economically worthwhile.

Recycling of the aqueous phase comprising ferrocyanide (V) to an aqueous phase comprising ferricyanide (IV) is theoretically possible by re-oxidation. Chemical methods of re-oxidation are practically infeasible, since accumulation of by-products in the aqueous phase could negatively affect the re-use of the aqueous phase comprising ferricyanide (IV) e.g. for oxidizing an intermediate of formula (II) to an intermediate of formula (III). Further, said accumulation of by-products could limit the number of re-use cycles.

The problem to be solved therefore concerns finding a practical process to re-oxidize an aqueous phase comprising ferrocyanide (V) which is recovered from an oxidative phenolic coupling reaction, to an aqueous phase comprising ferricyanide (IV), (a) while avoiding chemical processes which would introduce by-products in the aqueous phase and (b) allowing repeated recycling of the aqueous phase comprising ferricyanide (IV) in an other oxidative phenolic coupling reaction, more in particular in the reaction of intermediate (II) to intermediate (III) in the total synthesis of galantamine (I).

Schematically, the problem can be illustrated using the particular example of the total synthesis of galantamine as depicted in Scheme 1.

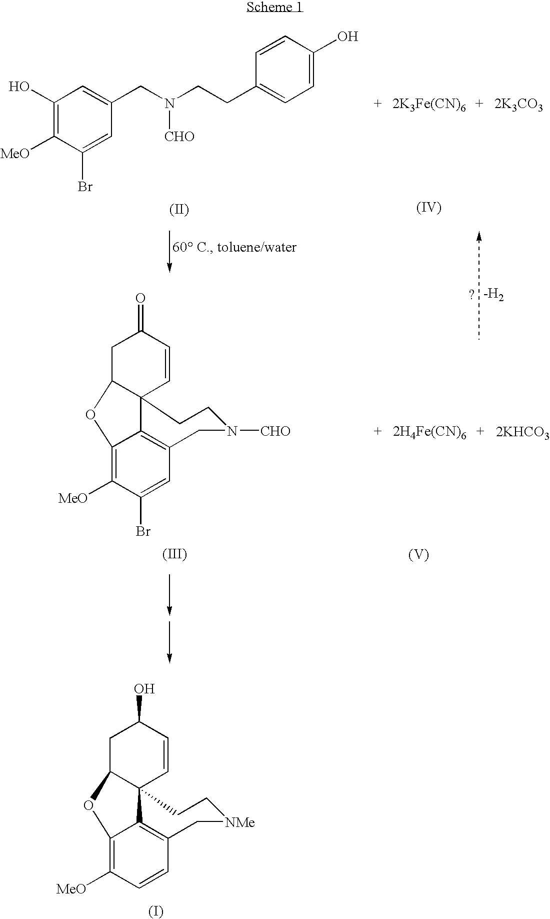

The present inventors provide herein a practical process for oxidizing an aqueous phase comprising ferrocyanide (V), which is recovered from an oxidative phenolic coupling reaction, to an aqueous phase comprising ferricyanide (IV), which does not use a chemical process which would introduce by-products in the aqueous phase, which allows repeated recycling of the aqueous phase comprising ferricyanide (IV) in an other oxidative phenolic coupling reaction, and which is readily adaptable to an industrial scale.

### DESCRIPTION OF THE INVENTION

The present invention provides a process for electrochemical oxidation of an aqueous phase comprising ferrocyanide (V), which is recovered from an oxidative phenolic coupling reaction to an aqueous phase comprising ferricyanide (IV), in a divided electrochemical cell, comprising preparing an anolyte comprising pretreating the aqueous phase comprising ferrocyanide (V) which is recovered from an oxidative phenolic coupling reaction by decantation or extraction or filtration; placing the anolyte in contact with an anodic electrode of the divided electrochemical cell; placing a catholyte in contact with a cathodic electrode of the divided electrochemical cell; and applying electrical power to the divided electrochemical cell, wherein the electrical power has an amperage or voltage and wherein the applying is for a time period sufficient to oxidize the ferrocyanide (V) to ferricyanide (IV). Since oxidation of ferro-(V) to ferricyanide (IV) is a reversible process, high conversion rates can only be obtained by use of a divided cell, that is a cell wherein the anolyte and catholyte are separated by a membrane. The membrane dividing the electrochemical cell is a cation selective membrane which preferably has high chemical and mechanical resistance. Materials permeable to cations, but largely impermeable to reactants and products, are used for membranes of divided electrochemically cells. The membrane performs as a separator and solid electrolyte in an electrochemical cell which requires the membrane to transport selectively cations across the cell junction.

An example of such a membrane is a perfluorinated polymer membrane such as perfluoropolyethylenesulfonic acid (Nafion®, DuPont). Other membranes materials include polytetrafluoroethylene (PFTE, e.g. Teflon®), polypropylene (e.g. Celgard®) membranes. Neither ferrocyanide (V) nor ferricyanide (IV) can migrate through the membrane to the cathode, but cations such as K⁺ are let through the membrane, generating a K⁺ transport from anolyte to catholyte.

Electro-oxidation occurs at the anode and thus the aqueous phase comprising ferrocyanide (V) which is recovered from an oxidative phenolic coupling reaction, is the anolyte. At the cathode, electro-reduction of protons yields hydrogen. The half-cell equations thus are:

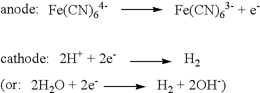

The main challenges when developing the process comprised
optimizing conversion of ferrocyanide (V) to ferricyanide (IV);
suppressing side reactions; and
obtaining an aqueous phase comprising ferricyanide (IV) effectively re-usable for oxidizing intermediate (II) to intermediate (III).

Multiple experiments with aqueous phases comprising ferrocyanide (V) which have been recovered from oxidative phenolic coupling reactions have taught the inventors that electro-oxidation of fresh or untreated phases produces erratic outcomes.

Untreated aqueous phases contain from about 2% to about 4% organic material and suspended free iron in the form of iron hydroxides. Whilst the impact of the organic material on the electro-oxidation process is currently not understood, the suspended free iron appears to block the electro-oxidation process by precipitating on the membrane of the divided cell and on the electrodes.

A conceptually easy—practically difficult, albeit not infeasible—method concerns pretreating the aqueous phase which comprises ferrocyanide (V) which is recovered from an oxidative phenolic coupling reaction, by storing it at 60° C. or more during a period of time sufficient to let precipitate suspended particles, and decanting the supernatant aqueous phase so as to separate it from the precipitated particles. A temperature of 60° C. or more is indicated to prevent the ferrocyanide (V) from precipitating from the aqueous phase. This method being feasible, is one not really acceptable in full-scale production because huge storage tanks containing the aqueous phase comprising ferrocyanide (V) would have to be occupied at a temperature of 60° C. or more during a period of time sufficient to let precipitate suspended particles.

Attempts to find a more practical solution to the problem outlined in the previous paragraphs have led the inventors to pretreating the aqueous phase comprising ferrocyanide (V) which is recovered from an oxidative phenolic coupling reaction, by extracting it with an organic solvent, preferably an aromatic hydrocarbon such as toluene which is the solvent used in the oxidative phenolic coupling reaction we are mainly interested in. Such a pretreated aqueous phase does not present the problem experienced with an untreated aqueous phase. This is very remarkable for two reasons.

First, we observed that an aqueous phase pretreated by extraction with an organic solvent such as toluene still contains suspended particles, but these do not seem to hinder the electro-oxidation reaction any longer.

Secondly, from a scientific point of view, one can conceptualise that the extraction procedure would remove organic material but less so free iron. The current understanding of the process is that removal of the suspended organic material would not be expected to have an impact on the electro-oxidation process, whereas removal of free iron would have. Our experiments seem to teach the opposite and no rationale for the observed phenomenon is currently available.

Another practical solution to the problem outlined in the previous paragraphs comprises pretreating the aqueous phase comprising ferrocyanide (V) which is recovered from an oxidative phenolic coupling reaction, by filtering it. At laboratory scale this is a filtration using for example a Buchner filter filled with cold filter aid, e.g. dicalite. On production scale the filtration step comprises adding the filter aid to the water layer and filtering over a preheated mono plate or multiplate filter.

The catholyte should allow current transport and should be conductive. It should not contribute significantly to side reactions. In a preferred embodiment, catholyte is prepared by dissolving an alkali metal hydroxide (e.g. KOH) or an alkali metal salt (e.g. K₂CO₃, KHCO₃, KCl, KCN) in water to give a 0.0001 M to 1 M solution. The catholyte may further comprise miscible organic solvents such as alkanols, e.g. methanol or ethanol.

During the process, the pH of the catholyte will rise as protons are removed from it, but in general this does not impact on the process.

For implementation, a MP-type membrane cell of ElectroCell N.V. (Sweden) was selected.

Various experiments were conducted at finding working conditions—and in particular optimal working conditions—for conducting the electro-oxidation process, outlined above, in a practical manner.

A series of anodic electrodes was tested and as a result of these experiments it was concluded that the best economic choice consisted of using a graphite electrode, although very expensive electrodes such as a dimensionally stable anode would be expected to work equally as well.

A series of cathodic electrodes was tested as well and as a result of these experiments it was concluded that some would not work, for example a lead electrode, though various others would, for example cathodic electrodes selected from the group of copper, nickel, stainless steel and graphite electrodes. Best results were obtained using a copper cathodic electrode or a graphite cathodic electrode

The experiments concerned with finding working conditions—in particular optimal working conditions—also concerned identifying the electrical power parameters to be applied to the divided electrochemical cell required to achieve the desired goal. On the one hand it was observed that the conversion rate of ferrocyanide (V) to ferricyanide (IV) was practically too slow when a voltage of less than 2 V was applied. On the other hand, a voltage above 2.8 V was found to cause generation of gaseous oxygen at the anode, a phenomenon clearly unacceptable from a security point of view. An optimum balance of maximizing conversion rate and minimizing oxygen production was found at a voltage of approximately 2.2 V to 2.6 V, in particular 2.6±0.1 V. Current density may range from about 20 mA/cm² to about 80 mA/cm², and preferably is about 40 mA/cm². The electrical power may be adjusted depending on the composition of the anolyte.

It was further observed that the process was preferentially conducted at a temperature of 60° C. or more so as to avoid precipitation of ferrocyanide (V). Further experiments have however shown that the process can equally well be conducted at the lower temperature of 50° C.

Higher temperatures such as 70° C. were investigated, but found not to have any significant influence on the outcome of the process. Thus, a temperature of about 50° C. of anolyte and catholyte would seem at this instant to represent an optimum temperature at which to operate the process according to the present invention.

The previously described process may occasionally tend to go wrong. In order to avoid the process to go wrong, one or more monitoring steps may be added to the in process control system.

Firstly, during the electro-oxidation process, the conversion of ferro (V) to ferricyanide (IV) may be blocked by precipitation of extraneous material on either the membrane or the electrodes. Such mishap may be monitored by recording of the current through the cell and aborting the process when the current drops.

Secondly, one may notice that the ferrocyanide (V) concentration in the anolyte fails to decay or that that of ferricyanide (IV) fails to raise during the process. The concentration of the ferrocyanide (V) and ferricyanide (IV) in the anolyte is therefore advantageously recorded during the process.

Thirdly, one should avoid that free cyanide (CN-) starts to form during the process and obviously, when that threatens to happen the process must be aborted immediately.

In order to deal timely with the previous eventualities, the process of the present invention will advantageously comprise monitoring steps in which all of the described phenomena are recorded and which trigger appropriate events such as process shut-down.

Electrical power conditions can be recorded using a computer controlled data logger (Grant Co., UK) which records cell voltage, current, temperature and pH, in preset intervals until the process is stopped.

In order to monitor the conversion of ferrocyanide (V) to ferricyanide (IV) during the electro-oxidation reaction, Fourier Transform Infrared (FTIR) spectroscopy may be used. This technique not only allows one to monitor said conversion and the end-point of the electro-oxidation, but also the unwanted generation of free cyanide (CN-). Absorbance of ferricyanide (IV) peaks at 2115 cm⁻¹, that of ferrocyanide (V) at 2035 cm⁻¹, and that of free cyanide (CN⁻) at 2080 cm⁻¹; each peak is sufficiently separated from the others to be clearly discernible.

On-line measurements can be accomplished by coupling the infrared spectrometer to an ATR-probe (Attenuated total reflection) which avoids sampling of the anolyte and also improves speed of analysis. As a back-up, provision may be made of a cerometric titration which involves a redox titration 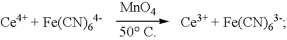
wherein ferroine indicator changes from orange-red to green.

In a further embodiment, the present invention concerns aqueous phases comprising ferricyanide (IV) obtainable by processes as described hereinbefore. Still further, the invention concerns the re-use of aqueous phases comprising ferricyanide (IV) obtainable by processes as described hereinbefore, for effecting oxidative phenolic coupling reactions on substrates susceptible to such reaction. Said re-use is particularly interesting for cyclizing a substrate of formula (II) to an intermediate of formula (III), which may be further converted into galantamine (I).

Experimental Part

### EXAMPLE 1

1.1 Set-Up and Procedure

The scheme of the electrochemical cell and the auxiliary equipments are given in FIG. 1. The MP-cell (ElectroCell) had two electrodes with 100 cm² area each. The anode and cathode compartments were separated by a Nafion® membrane and the gap between the electrodes and the membrane was 5 mm. For even flow two inlets and outlets were provided on the cell. Pₐ, P_{c} diaphragm pumps (Teflon® pump-head, Cole-Parmer, USA) of controlled flow rate were used to circulate the anolyte and catholyte. The fluids leaving the compartments were led to glass storage vessels Sa, Sc equipped with openings for sampling and introduction of sensors (e.g. pH electrode). From the storage vessels the liquids entered the heat exchange coils placed in the same heating-cooling thermostat (Cole-Parmer, USA). From the coils they were introduced into the pumps. Only Teflon® tubing was applied.

The power supply was a 40 A capacity potentiostat P.S., operating in controlled cell voltage mode. A computer controlled data logger D.L. (Grant Co., UK) served for data collection. It read cell voltage, current, temperature and the pH in preset intervals till the reading was stopped.

1.2 Procedure Prior the Electrolysis

The thermostat was heated to the required temperature, then the cathode storage vessel was filled with 500 ml of 0.5 M NaCl solution. Thermometer, temperature probe and pH electrode were placed and circulation of catholyte was started to reach the required temperature.

250 ml process water heated to about 70° C. was placed into the Sa anode storage vessel and its circulation was started.

The potentiostat and the data logger program were set, and as the temperature of the liquids were equilibrated the reading by the data logger was initiated and the current was switched on with the required cell voltage.

The electrolysis of 250 ml process water was carried out generally for 40 min. 1 ml samples of anolyte and catholyte were taken for ferrocyanide and K⁺ analysis at 10, 20, 30, 50, 70 min. After 40 min. the electrolysis was stopped, the pH electrode was removed and washed.

1.3 Cell Cleaning.

Following the electrolysis, the MP-cell was cleaned according to the following procedure: first, the anolyte was removed by pumping. The tubing from the anodic compartment of the cell to the storage vessel Sa was taken out and the anolyte was discarded through this outlet. The anode compartment was washed by introducing 250 ml water into the storage vessel and pumping it through the cell. Washing was continued till the liquid became colorless. The cathodic compartment was washed in similar way till the liquid reached pH=7. Cleaning the anode compartment was more tedious. It required about 3-4 times more water as compared to the cathodic compartment.

In the investigations we started with process water which had been left standing and decanted. This water will be called “old” water. Two other types of process water were also supplied. One was a “fresh” or untreated and the other was a “toluene extracted” water. Both waters had a pH around 9.3.

During the experiments with the “fresh” or untreated process water, a brown layer was formed on the wall of Sa storage vessel and by each electrolysis a smaller current was observed at the same cell voltage. The layer was easily dissolved from the vessel by a 5% HCl solution.

Analysis of the resulting solution indicated that iron-hydroxide/oxide formation occurred. A similar acidic treatment of the anodic compartment resulted in blue liquid indicating that the layers on the internal walls of the compartment contained hexacyanoferrate ions. On acidic treatment the iron-hydroxide/oxide dissolved and a KFe[Fe(CN)₆] or Fe₄(Fe(CN)₆)₃ precipitate formed, both blue in color. These precipitates were soluble and could be washed out. The remaining sticky part could be decomposed by treatment with an alkaline solution. Repeating the acid-alkaline sequence 3-4 times, the deposited layers were removed from the anodic compartment and working conditions were regained.

The build-up of an oxide layer occurred in the cell as well, and after some runs, work ceased to be reproducible.

Reproducibility was restored only if we cleaned the cell by pumping 100 ml 5% HCl, 250 ml water, 100 ml 5% NaOH and 250 ml water three times in sequence with 165 ml/min flow rate.

Besides the previously described layer formation, another difficulty arose with the use of “fresh” process water, as well. It was observed that, after starting the electrolysis a brown precipitate appeared in the catholyte which proved to be Fe(OH)₂/Fe(OH)₃. It formed from the free Fe ions coming through the cation conducting acidic Nafion® membrane. As they entered the alkaline catholyte, precipitation occurred. Formation of precipitate was observed only in the initial couple minutes of the electrolysis. Replacing the catholyte with new solution, no further contamination showed up. Toluene extracted process water was more “pleasant”, as there appeared to be no transport of Fe ions through the membrane into the catholyte and layer formation in the anodic compartment was not disturbing. In the “old” water, brown powder like precipitate accumulated during standing, which proved to be Fe-oxide. Determination by filtering out the sediment from 390 ml water, washing it with alkaline solution and drying gave 0.251 g/dm³ i.e. 0.00157 mole/l iron oxide.

At the beginning of the titration, a blue color appeared showing the formation of Prussian Blue precipitate which can be formed only if free Fe ions are available. Quantitative determination of the amounts was not successful.

The pH was practically the same in “fresh” and “toluene extracted” waters (“fresh” water: pH=9.37 and “toluene extracted” water: pH=9.43).

1.4 Analysis

Anolyte samples of 1 ml volume were taken to determine the concentration of Fe(CN)₆⁴^{^{−}} ions by titrating with acidic 0.05 M Ce(SO₄)₂ solution and ferroine indication. The Ce(IV) ions oxidized the Fe(CN)₆⁴^{^{−}} ions to Fe(CN)₆³^{^{−}}.

To follow the transport of K⁺ ions through the membrane, catholyte samples of 1 ml were taken and the K⁺ content was analyzed by ion-sensitive electrode (RADELKISZ, Hungary). Before each analysis the electrode was calibrated by measuring its potential against saturated calomel electrode (sce) in 0.1, 0.01 and 0.001 M KCl solution. These data provided a calibration curve.

1.5 Replacing the Electrodes in the Cell

The cell was equipped with Cu cathode and graphite anode since according to our preliminary work they were the most suitable couple. Beside these electrodes, stainless steel cathode and graphite felt covered graphite anode and Ni anode were tested, as well. The electrodes could be replaced without difficulty.

1.6 Basic Operating Features

The basic features of the oxidation were established by using a Cu cathode and a graphite anode. These materials were the most promising in previous studies. The graphite is thermodynamically fairly stable against oxidation although considerable overpotential is required. It is anticipated that even if oxidation occurs, the products of graphite oxidation will be less disturbing than ions of metal anodes, in the organic reactions in which the recycled ferricyanide (IV) solution is contemplated going to be re-used.

Ranges of operating parameters:

Cell voltage: 2.00-2.80 V. Below 2.00 V the conversion rate was too low to be practical, and above 2.80 V strong gas evolution occurred at the anode. Actually, gas evolution occurred at 2.80 V cell voltage after about 20 min. of electrolysis. The operative range in cell voltage was 2.20 V-2.60 V.

Temperature: 60-70° C. At lower temperature the solubility of Fe(CN)₆³^{^{−}}/Fe(CN)₆⁴^{^{−}} complex is low. The upper value is determined by the thermal stability of the electrocell materials. Most experiments were carried out at 60° C.

Pump speed: 100-500 ml/min. With smaller rates, the heat transfer to the cell by the fluid flow was not sufficient to maintain the temperature and at faster rates high pressures and trembling built up in the system (the internal diameter of the tubing was not sufficient for faster pumping). Temporary faster rates did not affect the current. The usual rate was 405 ml/min.

### EXAMPLE 2

2.1 Observations With Various Electrodes:

2.1.1 Cu Cathode and Graphite Anode.

2.1.1.1 “Old” Process Water

The initial work with the MP-cell was done with “old” process water. This water was stored for about a year. The reproducibility of the electro-oxidation process was quite good. In the initial period, the currents increased with the cell voltage since there was a sufficient amount of Fe(CN)₆⁴^{^{−}} to maintain the increased reaction rate. As the current decreased it became independent of the cell voltage as it was controlled by the transport but, in the final period the current increased again with the cell voltage. That change was due to the fact that since the cell voltage was constant, with the decreasing rate of the oxidation of Fe(CN)₆⁴^{^{−}}-new reactions started and their contribution became larger with the electrolysis time. These reactions may have been (i) oxidation of organic contaminants in the water, (ii) oxidation of the graphite anode or (iii), oxygen evolution. It was observed that, at 2.80 V cell voltage, gas evolution started at about 20 min. of electrolysis time in all experiments and the anolyte entering the storage vessel from the cell became more and more foamy. Conversion of Fe(CN)₆⁴^{^{−}} calculated from the titration data was more than 80% in 60-70 min. electrolysis.

2.1.1.2 “Fresh” Water

An experiment at 2.00 V was stopped early because of low current. During the work, it turned out that, precipitation on the membrane and anode decreased the current and that reproducible work was only possible if cleaning procedures as described in 1.3 were applied.

2.1.2 Toluene Extracted Water

2.1.2.1 Cu Cathode and Graphite Anode

With this water we did not experience the difficulties described above for the “fresh” water, although a finely dispersed sediment was found at the bottom of each container where we stored the water.

The change in current with time followed a similar pattern as in the previous cases. The flow rate was 405 ml/min. The increased cell voltage caused an increase in the initial current but for a shorter period. About 80% conversion was achieved in 90 min. at 2.40 V and in 70 min. at 2.60 V.

The conversion was proportional to the charge passed, although in the initial period there was a cell voltage dependent variation. When the ratio of charge passed, calculated by titration of oxidized complex and the charge passed by the current are plotted, the most suitable condition seem to be at 2.40 V.

2.1.2.2 Stainless Steel (SS) Cathode and Graphite Anode

When the first electrolysis with the SS cathode was carried out at 2.20 V., the current was unexpectedly low. It seemed that this first run provided an activation of the cathode, as the next electrolysis at 2.40 V provided a current in the expected range. The electrolysis at 2.60 V behaved as anticipated but at 2.80 V the current started to fall very soon though it remained nearly constant till the run was stopped. Strong gas evolution proved that other processes were going at this voltage. Following this electrolysis, we returned to 2.20 V and the current observed was what we would have expected.

The conversion did not reach the level seen with the Cu-graphite electrodes, FIG. 17. In 70 min. it was around 70-80%.

2.1.2.3 Stainless Steel (SS) Cathode and Graphite Felt Anode

The aim of trying a graphite felt anode was to increase the current density. The graphite felt was glued to the surface of a solid graphite providing very high surface area. The electrolysis carried out at 2.20 V was running with larger current as compared to the solid graphite anode and it remained constant for nearly the whole time of electrolysis with a steep drop towards the end. These features were very promising. Unfortunately, the cleaning of the electrode was very tedious because of the adsorption of organic content. Applying the usual acidic cleaning procedure resulted in a pink-maroon coloration of the washing water which did not stop, probably because of decomposition of the glueing agent. This phenomena made this composite material useless for our purpose and no further experiments were done with it.

2.1.2.4 Stainless Steel (SS) Cathode and Ni Anode

As the thermodynamic stability of Ni against oxidation is similar to that of graphite it was assumed that it could be worthwhile to test this metal as anode although in a more narrow cell voltage range.

The current fell off very soon and unfortunately Ni dissolution occurred. For these reasons we disregarded Ni as anode material.

2.2 Conclusions

These experiments support the preliminary studies that Cu or stainless steel cathode and graphite anode can be considered as the most suitable electrodes.

Although it was not expected that a change of cathode material would influence conversion, in the case of a stainless steel cathode, conversion was less than in the case of a Cu cathode. This effect may arise indirectly through a different overpotential distribution.

On the Cu cathode, fine surface roughening was observed. No change was seen on a stainless steel cathode and the graphite anode was stable, as well.

### EXAMPLE 3

3.1 Effect of Flow Rate

The flow of the anolyte and catholyte fluids was controlled to have the same rate. Different flow rate (slower or faster catholyte flow) did not effect the current. The volumes of anolyte were 250 ml but at 500 ml/min. flow rate we had to use 500 ml volume to prevent air intake due to the fast suction. An increase in flow rate did not affect the current in the initial period, but did towards the end of the reaction due to the larger transport. Thus, faster anolyte flow can be beneficial. In our set up, the flow rate could not be increased further. In the experimental work we applied 405 ml/min.

3.2 Effect of Organic Content on Current

Comparing the rates of oxidation observed in various arrangements at the same e.g. 2.20 V cell voltage, it can be concluded that the initial rate at t=0 is nearly the same. Current is in the range of 4.0-4.5 A with exception of graphite felt which has a much larger surface area. Differences which are a consequence of the water composition can be seen in the time dependence of the current.

Considering the effect of organic content, the “old” water can be disregarded since it was used as an introductory sample and the “fresh” and the “toluene extracted” waters are of importance. The strong tendency of the “fresh” water to form layers of precipitates, illustrates the importance of treating the aqueous phase waste stream before it is recycled in the cell.

Extraction with toluene provides an aqueous phase suitable as an anolyte. It apparently modified the free Fe ion content and no precipitation occurred in the catholyte. The extraction also modified the organic content and although with this water there was some layer formation, too, it did not block the anode and the membrane.

Alternative, we tried to remove organic materials from “fresh” water by adsorption on charcoal, but this was not successful.

Our conclusion is that the extraction with toluene is a useful procedure to decrease the blockage.

3.3 Hydrogen Evolution

As the catholyte contains only NaCl, the cathodic reaction must be
2H₂O+2e=H₂+2OH⁻

The amount of H₂ can be calculated from the current by the Faraday-rule. Thus, 1 A current in 1 s time (Q=1A*1s=1 As) produces 1/(2*96600)=5.18*10⁻⁶ mole i.e. 1.24*10⁻⁴ l H2. In our experiments the ferrocyanide (V) content of 250 ml process water required about 20000 As and 2.48 l H₂ formed at the expense of reaction of 1.86 g (about 1.86 ml) water. That amount is too small to see the change in the volume of 500 ml catholyte, especially if we consider that with the transport of K⁺ ions through the membrane, water transport occurs as well, even overcompensating the loss.

3.4 Effect of cell voltage on ion and water transport through the membrane

The K⁺ transport was followed in each experiment by applying ion sensitive electrode for determination of K⁺ concentration in the catholyte samples taken at the same time of anolyte samples for ferrocyanide titration.

3.5 Effect of Temperature

The effect of temperature was measured at 2.20 V cell voltage with 405 ml/min. flow rate. The effect was small and a positive effect could be seen only in the initial period, while at the final period the current was larger at lower temperature since in the initial period less complex was transferred. It might be considered that the operative temperature could be up to 70° C. In our experiments we applied 60° C.

Heat generation due to the electrolysis current was negligible, since the current density was low (max. 40 mA/cm²) and the liquid flow in the 5 mm thick compartments provided sufficient heat exchange to stabilize the temperature.

3.6 Change in pH of Catholyte

The pH of catholyte was monitored and recorded in each experiment. The pH increased fast to about pH=10.5 then slowly to about pH=11. This pattern was typical for all experiments. Simultaneous measurements of anolyte and catholyte with the same logger was not possible because of cell voltage interference, so we only recorded the pH of catholyte. The pH of the anolyte was measured following the experiment. The initial pH=8.9 of anolyte practically did not change with the electrolysis.

3.7 Conclusions

The following parameters are advised:
Electrodes: Cu cathode, graphite (solid) anode (Stainless steel and graphite cathodes are suitable as well)
The range of cell voltage: 2.20 V -2.60 V
The range of operating temperature: 60° C.-70° C.
Flow rate: both anolyte and catholyte; 400 ml/min-700 ml/min (upper value is to be tested in the SYN-cell)
Water pre-treatment preconditioning: extraction by toluene
Cell cleaning: First: anode compartment cleaning
   draining the compartment
   washing with deionized water till decoloration
   bleaching with 5% HCl solution
   bleaching with deionized water
   bleaching with 5% NaOH solution
   bleaching with deionized water
      Second: cathode compartment cleaning
   draining the compartment
   washing with deionized water till the acidity of effluent is pH=7
      4. Re-Use Example

Procedure to prepare intermediate (III) using recycled anolyte from the electrooxidation:4.5 g K₃Fe(CN)₆ and 5.9 g K₂CO₃ was added to 125 ml of anolyte, result of electro-oxidation, with the following analytical data: 174.6 mg/ml K₃Fe(CN)₆, 21.2 mg/ml K₄Fe(CN)₆, potassium concentration c(K⁺)=2.38 M. This solution was added to a 500 ml four neck round bottom flask fitted with mechanical stirring, reflux condenser and nitrogen inlet, containing 228 ml of toluene and 7.6 g of intermediate (II). The mixture was stirred and heated to 55° C. for 9 h, allowed to cool without stirring to room temperature and filtered. The filtered solid was washed with 44 ml of toluene, the unified liquids were separated. The aqueous layer was washed with 50 ml of toluene, the unified toluene phases were dried on Na₂SO₄ and evaporated to get 2.6 g of a solid containing (quantitative LC) 83.3 % of intermediate (III).

Alternatively, the anolyte resulting from the electro-oxidation may be rendered basic by addition of an appropriate amount of the catholyte solution resulting from the electro-oxidation, instead of adding K₂CO₃ as in the example above.

5. Multiple Re-Use Example Starting With Electro-Oxidation of a Ferrocyanide Solution

In the following example, ferricyanide was obtained from ferrocyanide which is less expensive, and we performed 5 cycles of electro-oxidation and oxidative phenolic coupling reaction.

A solution of ferrocyanide (1.22 g; 0.057 mol/100 g), KHCO₃ (33 g) in water (359 ml) at 50° C. was electro-oxidized at 2.6 V to ferricyanide (90% conversion; 0.051 mol/100 g) (ELOX1). Potassium hydroxide and other ingredients were added hereto to compensate the loss of K⁺ and the lowering of the pH (Table A).

This solution was used in the oxidative phenolic coupling of intermediate (II) (25 g) to intermediate (III) (Reaction 1). Upon completion of the reaction, the warm reaction mixture was decanted and the liquid phase transferred to a separation funnel for separating the water layer from the organic layer. The organic layer was dried and concentrated by azeotropic distillation and intermediate (III) was isolated as described before. The yield and the amount of impurities was determined (Table B).

The warm water layer was filtered over decalite, analysed for impurities (Table C) and reconstituted with depleted reagents (Table D), and then subjected to electro-oxidation as described hereinbefore (50° C., 2.6 V) (ELOX2).

After electro-oxidation, the amounts of ferri- and ferrocyanide, the concentration of K⁺ and H⁺, and the presence of organic contaminants was determined and reagents were added in amounts sufficient to reconstitute a solution as obtained after ELOX1 (see Table A).

The thus obtained solution was re-used in the oxidative phenolic coupling reaction (Reaction 2), and the above-described procedures were repeated throughout ELOX5 and Reaction 5.

The following Tables A to D provide details for each of the electro-oxidation and oxidative phenolic coupling reactions of the present example.

TABLE A
Amount of ingredients (g) added after the electro-oxidation before
transfer to the organic reaction.

| | ELOX1 | ELOX2 | ELOX3 | ELOX4 | ELOX5 |
|---|---|---|---|---|---|
| mass water | 30.1 | 3.7 | 21.3 | 13.6 | 19.2 |
| mass ferri | 9.6 | 4.3 | 7.8 | 7.2 | 8.5 |
| mass ferro | 1.4 | 0.6 | 1.1 | 2.4 | 1.3 |
| mass K₂CO₃ | 2.0 | 2.3 | 4.5 | 9.3 | 8.1 |
| mass KOH | 14.4 | 14.5 | 12.3 | 12.4 | 13.6 |

TABLE B
Yield and impurity profile of the organic layer.

| | Reaction | | | | |
|---|---|---|---|---|---|
| | 1 | 2 | 3 | 4 | 5 |
| wt % (II) | 1.25 | 1.23 | 1.18 | 1.17 | 1.13 |
| wt % (III) | 0.048 | 0.03 | 0.051 | 0.052 | 0.057 |
| impurity 1 | 0.04 | 0.034 | 0.038 | 0.034 | 0.034 |
| impurity 2 | 0.071 | 0.057 | 0.063 | 0.062 | 0.026 |
| rest | 0 | 0.001 | 0 | 0 | 0.005 |
| Yield | 33 | 33 | 31 | 31 | 30 |

TABLE C
Impurity profile of the water layer.

| | 1 | | | | |
|---|---|---|---|---|---|
| | (analytical | | | | |
| Water layer | pure) | 2 | 3 | 4 | 5 |
| wt % (II) | — | 0 | 0 | 0 | 0 |
| wt % (III) | — | 0 | 0 | 0 | 0 |
| impurity 3 | — | 0.043 | 0.048 | 0.047 | 0.046 |
| impurity 4 | — | 0.015 | 0.017 | 0.025 | 0.029 |
| rest | — | 0.001 | 0.001 | 0.003 | 0.005 |

TABLE D
Amount of ingredients added to the water layer obtained from the organic
reaction before transfer to the electro-oxidation.

| (g) | ELOX2 | ELOX3 | ELOX4 | ELOX5 |
|---|---|---|---|---|
| Ferro-cyanide | 44.8 | 34.7 | 42.8 | 38.7 |
| KHCO₃ | 11.9 | 9.3 | 11.9 | 10.2 |
| water | 131.9 | 102.4 | 125.0 | 115.2 |

1. A process for oxidizing an aqueous phase comprising ferrocyanide (V) which is recovered from an oxidative phenolic coupling reaction, to an aqueous phase comprising ferricyanide (IV), in a divided electrochemical cell, comprising
preparing an anolyte comprising pretreating the aqueous phase comprising ferrocyanide (V) which is recovered from an oxidative phenolic coupling reaction by decantation or extraction or filtration;
placing the anolyte in contact with an anodic electrode of the divided electrochemical cell;
placing a catholyte in contact with a cathodic electrode of the divided electrochemical cell;
and applying electrical power to the divided electrochemical cell, wherein the electrical power has an amperage or voltage and wherein the applying is for a time period sufficient to oxidize the ferrocyanide (V) to ferricyanide (IV).

2. The process of claim 1 wherein the divided electrochemical cell is divided by a cation selective membrane.

3. The process of claim 2 wherein the cation selective membrane is a Nafion® perfluorinated polyethylene sulfonic acid membrane.

4. The process of claim 1 wherein the pre-treatment of the aqueous phase comprising ferrocyanide (V) which is recovered from an oxidative phenolic coupling reaction comprises
storing said aqueous phase at 60° C. or more during a period of time sufficient to let precipitate suspended particles and decanting the supernatant aqueous phase so as to separate it from the precipitated particles.

5. The process of claim 1 wherein the pre-treatment of the aqueous phase comprising ferrocyanide (V) which is recovered from an oxidative phenolic coupling reaction comprises extracting the aqueous phase with an organic solvent.

6. The process of claim 1 wherein the pre-treatment of the aqueous phase comprising ferrocyanide (V) which is recovered from an oxidative phenolic coupling reaction comprises filtering the aqueous phase.

7. The process of claim 1 wherein the catholyte comprises an alkali metal hydroxy or an alkali metal salt (e.g. KOH, K₂CO₃, KHCO₃, KCl, KCN) solution having a concentration in the range of from 0.0001 to 1 M.

8. The process of claim 1 wherein the anodic electrode is graphite; and the cathodic electrode is selected from the group of copper, nickel, stainless steel and graphite.

9. The process of claim 1 wherein the electrical power applied to the divided electrochemical cell has a voltage between 2 V and 2.6 V.

10. The process of claim 9 wherein the voltage is 2.6 V±0.1 V.

11. The process of claim 1 wherein the anolyte and catholyte are kept at a temperature of 50° C. or more.

12. The process of claim 1 further comprising one or all of the monitoring steps selected from the group of
recording of the current passing through the divided electrochemical cell;
recording of the ferrocyanide (V) concentration decay;
recording of the ferricyanide (IV) concentration accumulation;
recording of the apparition of free cyanide (CN—); and
recording of the conductivity of the catholyte.

13. An aqueous phase comprising ferricyanide (IV) obtainable by a process as described in claim 1.

14. Use of an aqueous phase comprising ferricyanide (IV) as described in claim 13 for effecting an oxidative phenolic coupling reaction on substrates susceptible to such reaction.

15. The use of claim 14 wherein the oxidative phenolic coupling reaction is conducted on the substrate of formula (II) 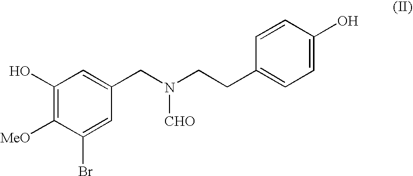
yielding a compound of formula (III) [chemical structure]
